(19) United States
(12) Patent Application Publication
(10) Pub. No.: US 2003/0004781 A1
(43) Pub. Date: Jan. 2, 2003

(54) Method and system for predicting aggregate behavior using on-line interest data

(76) Inventors: Kenneth P. Mallon, Los Altos, CA (US); Kian-Tat Lim, Palo Alto, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/884,821

(22) Filed: Jun. 18, 2001

(51) Int. Cl. G06F 17/60

(52) U.S. Cl. 705/10

(57) ABSTRACT

A method of predicting aggregate behavior of a population is provided. A modeling system configured to model aggregate behavior of a population as a function of aggregate on-line interest data is provided. The on-line interest data is based on passive observation of on-line behavior of a subpopulation, wherein the on-line behavior is related to, but different than, the behavior to be modeled, and wherein the subpopulation comprises a subset of the population. On-line interest data related to a subject is input to the modeling system. A prediction of aggregate behavior related to the subject is generated with the modeling system.

### FIELD OF THE INVENTION

The present invention relates to methods and systems for providing a prediction of aggregate behavior. Particularly, the present invention relates to methods and systems for providing a prediction of aggregate behavior using aggregate on-line interest data.

### BACKGROUND OF THE INVENTION

When bringing a product or service to market, it is useful to have some measure of the demand for that product ahead of time. Such information may be used, for example, to adjust production of a product so that the supply of the product will approach the expected demand. Additionally, marketing of the product or service can be adjusted in an attempt to effect the expected demand so that it is more in line with a goal.

Techniques have been developed that attempt to predict demand for a good, service, etc. For example, techniques have been developed that attempt to predict success of a movie as measured by box office receipts. One approach that predicts a movie's success uses survey research with other movie information such as the genre of the movie, the number of theaters showing the movie, the movie's rating, and success of past movies that included the leading actor(s). Surveys are taken of individuals in order to understand peoples' awareness and intentions, and such information can be used to generate predictions. However, surveys require active questioning of individuals to elicit information. Thus, in cases where large sample sizes are required for a desired accuracy, surveys may be expensive because large numbers of people must be questioned. Additionally, surveys introduce bias into the prediction which reduces its accuracy. For instance, some people may be more inclined to complete a survey than others, and the awareness, intentions, etc., of those people who tend to complete surveys may be biased as compared to the population as a whole. Additionally, the form of the questions on a survey may introduce bias (i.e., question bias).

Techniques have been developed that use the Internet to conduct on-line surveys. Such on-line surveys may achieve large sample sizes less expensively. However, because on-line surveys rely on active questioning, such surveys have the same problem of introducing bias as do off-line surveys.

Additionally, techniques have been developed that use an individual's past on-line behavior to predict a future on-line action by that individual. For example, Internet usage statistics for an individual have been used for targeted banner advertising on a web page transmitted to the user. Particularly, the individual's past Internet behavior is used to predict which of a number of banner advertisements the individual would be more likely to click through and make a purchase. Banner advertisements to which the user are more likely to positively respond are included on the web page sent to the user rather than advertisements which the user would likely ignore.

### BRIEF SUMMARY OF THE INVENTION

According to the present invention, methods and systems are provided for predicting aggregate behavior of populations with aggregate on-line interest data, the on-line interest data based on passive observation of on-line behavior, wherein the on-line behavior is related to, but different than, the behavior to be modeled. The aggregate behavior to be predicted may be, for example, aggregate economic activity related to a good, service, or financial security. Also, the aggregate behavior to be predicted may be, for example, an extent of a disease.

In a specific embodiment, a method of predicting aggregate behavior of a population is provided. The method comprises providing a modeling system configured to model aggregate behavior of a population as a function of aggregate on-line interest data. The on-line interest data is based on passive observation of on-line behavior of a subpopulation, wherein the on-line behavior is related to, but different than, the behavior to be modeled, and wherein the subpopulation comprises a subset of the population. The method also comprises inputting to the modeling system on-line interest data related to a subject, and generating, with the modeling system, a prediction of aggregate behavior related to the subject.

In another embodiment, a system for predicting aggregate behavior of a population is provided. The system includes a modeling system configured to model aggregate behavior of a population as a function of aggregate on-line interest data. The on-line interest data is based on passive observation of on-line behavior of a subpopulation, wherein the on-line behavior is related to, but different than, the behavior to be modeled, and wherein the subpopulation comprises a subset of the population. The system additionally includes a module for receiving on-line interest data related to a subject and providing the on-line interest data to the modeling system, wherein the modeling system generates a prediction of aggregate behavior related to the subject using the on-line interest data.

In another aspect of the present invention, a method of training a modeling system to predict aggregate behavior of a population is provided. The method comprises providing a modeling system, and providing a learning data set. The learning data set includes actual aggregate behavior data related to a subject, and aggregate on-line interest data related to the subject. The on-line interest data is based on passive observation of on-line behavior of a subpopulation, wherein the on-line behavior is related to, but different than, the actual behavior, and wherein the subpopulation comprises a subset of the population. The method also includes training the modeling system with the learning data set to minimize the error between a predicted aggregate behavior related to the subject generated by the modeling system and the actual aggregate behavior related to the subject.

In another embodiment, a method of predicting a measure of aggregate economic activity related to a product is provided. The method includes providing a modeling system configured to model aggregate economic activity of a type of product as a function of aggregate on-line interest data related to products comprising the type, wherein the on-line interest data is based on passive observation of on-line behavior of a subpopulation, wherein the on-line behavior is related to, but different than, the economic activity to be modeled, and wherein the subpopulation comprises a subset of a population that engages in the economic activity to be modeled. The method also includes inputting to the modeling system on-line interest data related to a product comprising the type. The method additionally includes generating a prediction of the measure of aggregate economic activity related to the product with the modeling system.

In yet another embodiment, a system for predicting a measure of aggregate economic activity related to a product is provided. The system comprises a modeling system configured to model aggregate economic activity of a type of product as a function of aggregate on-line interest data related to products comprising the type, wherein the on-line interest data is based on passive observation of on-line behavior of a subpopulation, wherein the on-line behavior is related to, but different than, the economic activity to be modeled, and wherein the subpopulation comprises a subset of a population that engages in the economic activity to be modeled. The system additionally comprises a module for receiving on-line interest data related to a product comprising the type and providing the on-line interest data to the modeling system, wherein the modeling system generates a predicted measure of economic activity related to the product using the on-line interest data.

In another aspect of the invention, a method of training a modeling system to predict aggregate economic activity related to a product comprising a type of products is provided. The method comprises providing a modeling system. The method additionally comprises providing a learning data set. The learning data set includes an actual measure of aggregate economic activity related to a product, and aggregate on-line interest data related to the product, the on-line interest data based on passive observation of on-line behavior of a subpopulation, wherein the on-line behavior is related to, but different than, the actual economic activity, and wherein the subpopulation comprises a subset of a population that engages in the economic activity. The method further comprises training the modeling system with the learning data set to minimize the error between a predicted measure of aggregate economic activity related to the product generated by the modeling system and the actual measure of aggregate economic activity related to the product.

Numerous advantages or benefits are achieved by way of the present invention over conventional techniques. In a specific embodiment, the present invention provides more accurate predictions of aggregate behavior. For example, on-line interest data based on passive observation of on-line behavior is used, thus, generally reducing bias in the predictions. Also, in some embodiments, large sample sizes can be achieved less expensively., thus, generally permitting increased accuracy and/or less expensive predictions. One or more of these advantages may be present depending upon the embodiment.

These and other embodiments of the present invention, as well as its advantages and features are described in more detail in conjunction with the text below and attached Figures.

### BRIEF DESCRIPTION OF THE DRAWINGS

FIG. 1 is a simplified block diagram of embodiment of an behavior predictor according to the present invention;

FIG. 2 is a simplified block diagram of basic subsystems in a representative computer system that may embody the present invention;

FIG. 3 is a simplified block diagram of a traffic monitor that may be included in some embodiments of the present invention; and

FIG. 4 is a simplified flow diagram of a method for generating a prediction of a measure of economic activity related to a product according to another embodiment of the invention.

### DESCRIPTION OF THE SPECIFIC EMBODIMENTS

Explanation of Terms

An explanation of the meaning and scope of various terms used in this description is provided below.

“Web” typically refers to “World Wide Web” (or just “the WWW”), a name given to the collection of hyperlinked documents accessible over the global Internetwork of networks known as the “Internet” using the HyperText Transport Protocol (HTTP). As used herein, “Web” might refer to the World Wide Web, a subset of the World Wide Web, a local collection of hyperlinked pages, or the like.

A server is a computing device that responds to requests from clients. A Web server is a server that is connected to the Internet (or smaller networks that use similar protocols) and that responds to requests received from Web clients over the Internet. As used herein, the term “Web server” may also refer to a plurality of servers organized to handle a large number of requests for a Web server, i.e., a distributed Web server system. The term “Web site” is often used to refer to a collection of Web servers organized by a business entity or other entity for their purposes. The term derives, most likely, from the language used to access one of those Web servers. A user is said to “go to a Web site” when the user directs his or her Web client to make a request of one or the site's Web servers and display the response to the user, even though the user and the Web client do not actually move physically. The user perception is that there is a location on the Web where this Web site exists, but it should be understood that the term “Web site” often refers to the Web server or servers that respond to requests from Web clients, even though “site” does not necessarily refer to the physical location of the Web servers. In fact, in many cases, the servers that serve up a Web site might be distributed physically to avoid downtime when local outages of power or network service occur.

The term “Web site” more typically refers to a collection of pages maintained by a common maintainer for presentation to visitors, whether the collection is maintained on one physical server at one physical location or is distributed over many locations and/or servers. The pages (or the data/program code needed to generate the pages dynamically) need not be created by the common maintainer of the collection of pages. In places herein, such a maintainer of the collection of pages is referred to as the Web site operator. As an example, an online merchant might set up a Web server with a collection of pages created by the merchant or obtained from affiliates, suppliers or partners of the merchant and then put hyperlinks in the pages such that a visitor can browse around the “site” as expected by the merchant. As another example, an individual dedicated to dispensing information about opera or an uncommon medical condition might set up a Web server and populate it with pages about their topic of dedication, including such things as references to pages outside their collection of pages, dynamically generated pages of comments made by visitors or e-mail sent to the operator of the Web server.

While many Web sites are targeted to single topics, some Web site operators serve many different interests and have integrated many different “properties” into a large Web site, often distributed over many servers and locations to handle traffic from a large number of visitors. For example, the Yahoo! Web site (initial URL: www.yahoo.com) brings together many properties of interest under one umbrella, including such properties as a financial property (for providing stock quotes and other financial information and data), a sports property (for providing sports scores and news), an auction property, a chat property, an instant messaging property and many others. Such sites, where visitors come for possibly unrelated properties, are often referred to as “portal sites”.

While the typical Web site includes one or more servers that receive requests and provides responses according to HTTP, the description herein should not be understood as being limited to a particular protocol or a particular network. For example, the Web site might be connected to the Web clients via an intranet, wireless access protocol (WAP) network, local area network (LAN), wide area network (WAN), virtual private network (VPN) or other network arrangement. In other words, a Web site for which traffic is being monitored can be monitored independent of the protocols or network used.

Typically, requests and responses are considered “pages”. For example, with the HTTP protocol, a Web client requests a page from a Web server and the Web server responds to the request by sending a page. In the HTTP protocol, a Uniform Resource Locator (“URL”) identifies a page and that URL is presented to the Web server as part of a request for a page. The pages are often HyperText Markup Language (HTML) pages or the like. The HTML pages can be static pages, dynamic pages or a combination. Static pages are pages that are stored on the server, or in storage accessible by the server, prior to the request and are sent from storage to the client in response to a request for that page. Dynamic pages are pages that are generated, in whole or in part, upon receipt of a request. For example, where the page is a view of data from a database, a server might generate the page dynamically using rules or templates and data from the database where the particular data used depends on the particular request made.

The term “page hit” refers to an event wherein a server receives a request for a page and then serves up the page. For even a moderate sized Web site, the servers might handle millions of page hits per day.

“On-line interest” in a subject refers to a level of interest in the subject as reflected in events related to the subject that occur on an internet, the Internet, an intranet, a WAP network, a LAN, a WAN, a VPN, or other network arrangement. “Events” can be, for example, page views, search requests, real or fictitious purchases, requests for media, financial security trades, message board actions, chat room actions, club actions, instant messaging actions, online gaming actions, etc.

A Basic Behavior predictor

Frequently, persons use the Internet to search for information on a particular subject, topic, product, service, etc. If interest in a particular subject, topic, product, service, etc., is high, it may be reflected in, for example, the number of searches for that subject, topic, etc., performed by users of the Internet. Furthermore, if interest in, for example, a particular product is high, this may indicate a high demand for the product. In turn, high demand for a product may be predictive of future sales of the product.

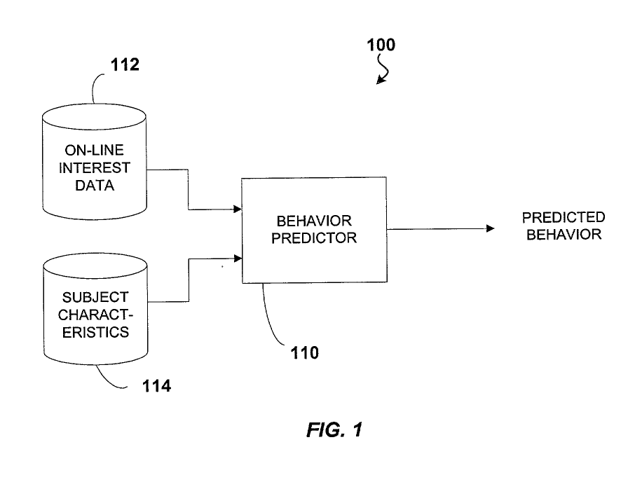

FIG. 1 is a simplified block diagram of an embodiment of a behavior predictor 110 that generates predictions of aggregate behavior related to a subject in accordance with the present invention. Examples of aggregate behavior related to a subject that may be predicted include, but are not limited to, a measure of economic activity related to a good, service, financial security, etc., or an extent of a disease. Examples of measures of economic activity are a number of, or dollar value of, sales of a product during a period of time. Other examples include, but are not limited to, supply, demand, trading, advertising, media coverage, or the like. Other aggregate behavior can be predicted without departing from the scope of the invention. The block diagram of FIG. 1 is used herein for illustrative purposes only and is not intended to limit the scope of the invention.

The behavior predictor 110 receives aggregate on-line interest data 112 relating to a subject and generates a prediction of aggregate behavior of a population related to the product. For example, the subject may be a movie, and the predicted aggregate behavior may be a number of people that see the movie, represented as, for example, a dollar value of box office sales.

On-line interest data 112 includes any data that shows a level of interest of a subpopulation in a subject. As is described in more detail below, the aggregate on-line interest data 112 includes data based on passive observation of on-line behavior of a subpopulation. Because the on-line data is based on passive observation, rather than active questioning, bias in the predictions can be reduced in some embodiments. Additionally, the on-line behavior of the subpopulation is related to, but different than, the behavior of the population to be modeled. Thus, embodiments of the present invention can be used to predict a wide variety of behavior. Additionally, it has been found that, in some embodiments, that accurate predictions can be generated for populations that may be much larger than the subpopulation that engages in the on-line behavior, thus, further increasing the variety of aggregate behavior that can be predicted.

In some embodiments, the behavior predictor 110 may also receive data 114 relating to characteristics of the subject. For example, if the subject is a movie, the subject characteristics data 114 may include data relating to the number of theaters showing the movie, the lead actor, etc. The data used by the behavior predictor 110 to generate a prediction of the aggregate behavior related to the subject (i.e., on-line interest data 112 and, in some embodiments, subject characteristics data 114) is described in more detail below.

Although, the on-line interest data 112 and subject characteristics data 114 relating to the product are symbolically depicted in FIG. 1 as databases, the behavior predictor 110 need not receive such data from databases. For example, behavior predictor 110 could receive such data from a network via a network connection, from a computer server, by reading an unstructured file or a structured text file, etc. For example, the data may be stored in an Extensible Markup Language (XML) file. Furthermore, the on-line interest data 112 and product characteristics data 114 need not be stored in two separate databases. Rather, such data may also be stored in one database, or distributed among two or more databases.

In some embodiments, behavior predictor 110 may be a computer system or program that uses a statistical model such as, for example, a linear regression model, a regression tree, a neural network, or other learning algorithms. Generally, the model applies weights to various data comprising the on-line interest data 112 relating to the subject, and, if used, data 114 relating to characteristics of the subject, and combines the weighted data to generate a value that is a predicted measure of aggregate behavior related to the subject. In these embodiments, the behavior predictor 110 is trained using a leaming data set that includes data on events that have occurred in the past. Once trained, the behavior predictor 110 may be used to generate an accurate prediction of aggregate behavior related to a subject. Training of the behavior predictor 110 and learning data sets are described in more detail below.

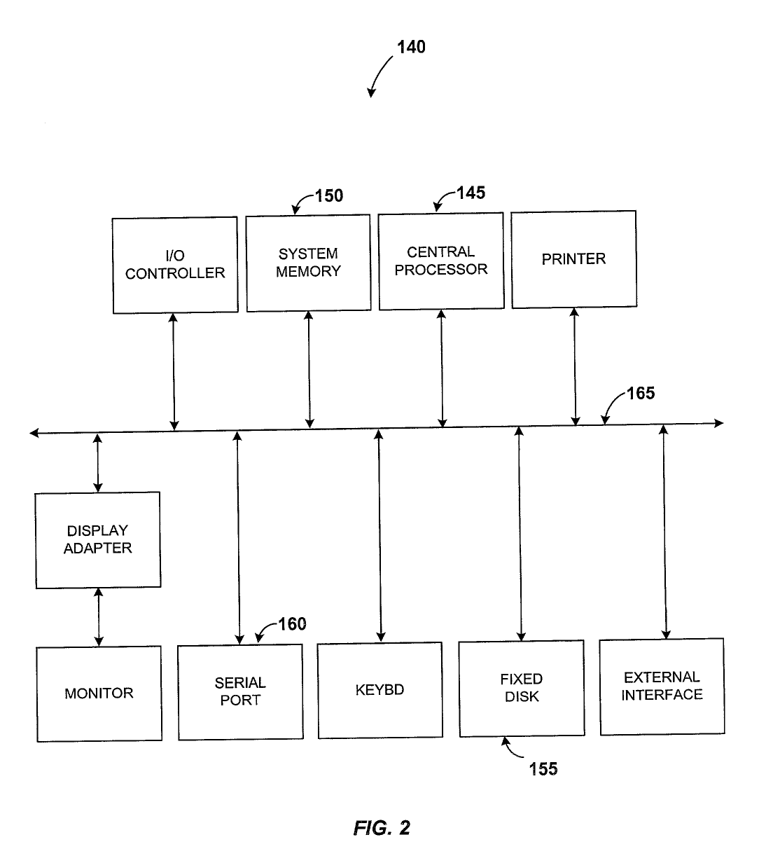

Embodiments according to the present invention can be implemented in a single application program, or can be implemented as multiple programs in a distributed computing environment, such as a workstation, personal computer or a remote terminal in a client server relationship. FIG. 2 is a simplified block diagram of basic subsystems in a representative computer system that may embody the present invention. FIG. 2 is representative of but one type of system for embodying the present invention. It will be readily apparent to one of ordinary skill in the art that many system types and configurations are suitable for use in conjunction with the present invention.

In certain embodiments, the subsystems such as a central processor 145, a system memory 150, a fixed disk 155, and a serial port 160 are interconnected via a system bus 155. Additional subsystems such as a printer, keyboard and others are shown. Peripherals and input/output (I/O) devices can be connected to the computer system by any number of means known in the art, such as serial port 160. For example, serial port 160 can be used to connect the computer system to a modem, which in turn connects to a wide area network such as the Internet, a mouse input device, or a scanner. The interconnection via system bus 165 allows central processor 145 to communicate with each subsystem and to control the execution of instructions from system memory 150 or the fixed disk 155, as well as the exchange of information between subsystems. Other arrangements of subsystems and interconnections are readily achievable by those of ordinary skill in the art. System memory 150, and the fixed disk 155 are examples of tangible media for storage of computer programs, other types of tangible media include floppy disks, removable hard disks, optical storage media such as CD-ROMs and bar codes, and semiconductor memories such as flash memory, read-only-memories (ROM), and battery backed memory.

Techniques for Measuring On-Line Interest

The following description provides an overview of techniques for measuring aggregate on-line interest in a topic, subject, product, etc. Any one or more of these techniques may be used in embodiments of the present invention. Also, depending upon the particular topic, subject, product, etc., for which on-line interest is to be measured, certain of these techniques may provide more accurate measures of online interest than others. Additionally, other like techniques may also be used to measure on-line interest without departing from the scope of the invention.

As described above, the aggregate on-line interest is generally based on passive observation of on-line behavior of a subpopulation. Additionally, the on-line behavior of the subpopulation is related to, but different than, the behavior of the population to be modeled. As is described below, on-line interest data can include on-line usage data, which can be based on events such as, for example, page views, searches, click streams, purchases, downloading media objects, message board postings, etc.

A common measure of traffic at a Web site is in the number of page hits (often referred to as “page views”, especially in an advertising context) for particular pages or sets of pages. Page hit counts are a rough measure of the traffic of a Web site. More refined measures include unique visitor counts, where only one page hit is counted for each unique client per some period. In the context of measuring online interest in, for example, a movie, page hits for one or more promotional web pages for the movie or web pages related to the movie (e.g., operated by a fan club) could be counted. Similarly, page hits for one or more web pages promoting or related to a lead actor in the movie (e.g., operated by a fan club) could be counted.

Such measures work well when the traffic of interest relates to particular pages, but are generally less informative when traffic by topic is desired and multiple pages may relate to one topic and one page may relate to multiple topics. For example, where a stock information Web server just serves up a page for each stock and only one page relates to that stock, it would be a simple matter to determine levels of user interest in particular stocks by just examining the server logs of the Web server to determine which stock pages are being served the most. Unfortunately, most real-world Web services are not so well defined. For example, the Yahoo! portal site includes servers that serve news, sports and financial content along with content on many different subjects and pages that relate to a common topic might be served from more than one of those content components. With the requests spread over different content components, the level of user interest would not be accurately reflected in just a measurement of interest in one content component. For example, interest in a particular athletic shoe company might be expressed by traffic to pages containing news stories relating to the company, traffic to sports pages referring to the company, traffic relating to financial content about the company, searches for the company's products, purchase transactions for the company's products, etc. Also, some requests might be falsely associated with interest in the company if, for example, users use a search term that has more than one meaning, where not all meanings relate to the name of the company.

A Web site might also include search capability, wherein a user submits a search request using their Web client and a Web server responds with a page that contains search results. It is a simple matter for a search engine (a Web site set up to respond to search requests) to log all of the search requests. Typically, a search request is in the form of a search phrase containing one or more search terms. Search requests can be counted by search term, e.g., count the number of times “Ford” or “sports” was used as a search word in a search phrase. Thus, in the context of measuring interest in, for example, a movie, the number of search requests including the movie's title or a portion of the title could be counted. Similarly, the number of search requests including a lead actor's name could be counted. However, such counts have limited utility where one search term might relate to multiple topics and multiple search terms might relate to one topic.

One Web site, the Hollywood Stock Exchanges® site (http://www.hsx.com) permits users to buy and sell “stock” in movies, music, and celebrities using fictional money. The Hollywood Stock Exchanged® site provides data on the stock prices, and the stock price of a movie, song, actor, etc., tends to rise and fall as on-line interest in the movie, song, actor, etc., rises and falls. Thus, on-line interest in, for example, a movie may be reflected in one or more of, for example, the movie's stock price, the volume of trades of the movie's stock, the stock price of the movie's lead actor, the volume of trades of the lead actor's stock, etc.

Some Web sites provide measurements of on-line interest in a topic, subject, product, etc. For example, the Yahoo! portal site provides a Yahoo! Buzz Index for various topics that measures the percentage of Yahoo! users searching for that topic on a given day. Thus, on-line interest in, for example, a movie may be reflected in one or more of the movie's Buzz Index, the Buzz Index of the movie's lead actor, etc.

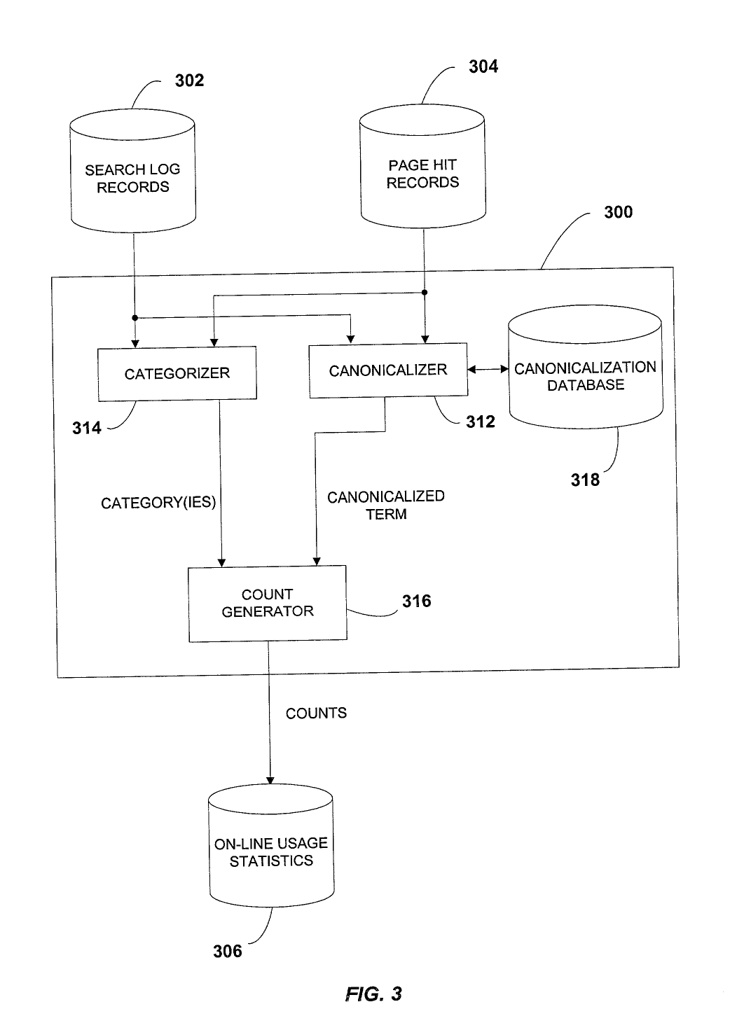

Further, U.S. Pat. No. ______ (U.S. application Ser. No. 09/654,405 to Yoo et al., filed Sep. 1, 2000) (hereinafter referred to as “Yoo”) describes embodiments of systems and methods for measuring online interest. Some of the embodiments described in Yoo are briefly described below. Further details are provided in Yoo which is herein incorporated by reference in its entirety for all purposes. FIG. 3 is a simplified block diagram of a system, as described in Yoo, for generating on-line usage statistics that reflect a level of on-line interest in a product according to one embodiment of the present invention. This diagram is used herein for illustrative purposes only and is not intended to limit the scope of the invention.

A traffic monitor 300 is coupled to receive search log records 302 and page hit records 304. The search log records 302 and page hit records 304 may comprise, for example, a database (or databases) that includes a log or logs of events recorded by a set of one or more servers. The set of servers may be, for example, the servers that serve content for one or more Web sites, the servers monitored by an advertising or ratings network, the servers monitored by a university network monitoring system, etc. Although, the search log records 302 and page hit records 304 are symbolically depicted in FIG. 3 as databases, the traffic monitor 300 need not receive such data from databases. For example, traffic monitor 300 could receive such data from a network via a network connection, from a computer server, by reading an unstructured file or a structured text file, etc. For example, the data may be stored in an XML file.

Traffic monitor 300 generates statistics that reflect a level of interest in a subject using data comprising the search log records 302 and page hit records 304. As used herein, “subject” generically refers to one or more of a topic, term, category, etc. For example, the topic “U.S. presidential politics”, the search term “ford” and the category “music”, are all subjects for which a level of interest can be measured. In some embodiments, traffic monitor 300 aggregates events into categories, and each category is associated with a subject. The categories may be organized hierarchically, with a first level of categories, subcategories within categories, possibly subcategories within subcategories, etc. For example, a category might be “autos”, and subcategories within “autos” might include “sedans” and “trucks”. Unless otherwise indicated, where “category” is used herein, it should be interpreted to refer to a category of subcategory.

Traffic monitor 300 generates a count of events associated with each category. Particularly, traffic monitor 300 reads the log or logs of events from search log records 302 and/or page hit records 304 and determines how to categorize each event. Traffic monitor 300 may determine an event to be associated with one or more categories. For example, an event might comprise a search request using the search phrase “formula one” and a resulting search results page listing pages related to algebra and auto racing. Thus, traffic monitor 300 may determine that this event is associated with mathematics and sports. Similarly, an event might include a search request using the search phrase “toyota camry”, and traffic monitor 300 may determine that this event is associated with the category “autos” and with the category “sedans”, which is a subcategory of “autos”. After traffic monitor 300 determines one or more categories to which the event is associated, a count or counts corresponding to the one or more categories is incremented. Thus, the number of counts for a particular category indicate a level of interest in that category. Traffic monitor 300 is coupled with an on-line usage statistics database 306, and traffic monitor 300 stores the counts for each category in the on-line usage statistics database 306. Referring again to FIG. 1, in some embodiments, the on-line usage statistics database 306 provides the on-line interest data 112 to the behavior predictor 110.

Details of a Traffic Monitor

Traffic monitor 300 includes a canonicalizer 312, a categorizer 314, a count generator 316 and a canonicalization database 318.

1. Canonicalization

Canonicalizer 312 is coupled to receive search log records and page hit records to determine, for a given search request or page hit, what the relevant topic is. Canonicalizer 312 might refer to canonicalization database 318 to resolve canonical terms. When dealing with search words, it often makes sense to combine information about similar terms that are intended to produce the same results. For example, a term may be misspelled, or it may have words in a different order than another, or it may contain non-essential words such as “the”. The process of reducing such terms to a common, standard form is known as canonicalization. Many processes are known for performing canonicalization, ranging from less aggressive processes such as removing certain punctuation characters or so-called “stop words” such as “of” and “the”, to more aggressive processes such as adding, changing or deleting letters within words.

A canonicalization process might be performed by canonicalizer 312. As an example, canonicalizer 312 might canonize the search phrase “Denver whether” to “weather” by inferring that a spelling error occurred. In some embodiments, canonicalizer 312 uses user behavior to improve the canonicalization process. Using user behavior is inherently scalable because there are generally proportionately more users to give human input as the system grows larger to handle more traffic. Using user behavior (a large increase in number of searches) also allows more aggressive canonicalization. For words whose search usage has increased rapidly, more aggressive canonicalization techniques can be used.

In some embodiments, canonicalizer 312 may respond to canonicalizations that change over time, as is often the case in the real world of user interests. When combined with other elements of the traffic monitor 300, the count values for terms that reflect actual user interests are readily available for use by the canonicalizer 312 to determine which topics/terms to merge and when. Various embodiments and variations of canonicalizer 312 and methods of canonicalization are described in more detail in Yoo.

2. Categorization

Categorizer 314 determines the category or categories that have their count incremented for a particular event. For example, where the event is a search request using the search phrase “formula one” and the search results page lists pages related to algebra and auto racing, the search might be categorized under mathematics or sports. In some embodiments, categorizer 314 correlates searches with search results selected, so that when the logs show that the user selected from the search results a page relating to auto racing, categorizer 314 allocates that event to the “auto racing” category and the “formula one” term in that category. Where terms remain ambiguous even after selection of a page (or if the user does not select a page from a search results page), categorizer 314 might output fractional counts for more than one category with suitable weights summing to one.

In some cases, the category associated with a page hit or a search are readily determinable by the state of a visitor's server session. For example, if the user is navigating a search directory by category/subcategory using a search term and then selects an entry under a subcategory, then the count for that event is readily allocable to the bin for the search term under the category and/or subcategory previously assigned to that entry. For example, if a user navigates the Yahoo! search directory path “Top: Sports: Regional Sports: San Jose” using the search term “scores” and selects a page from the result, then the categories and subcategories that get the count are readily ascertainable.

However, with direct searches with words having multiple meanings, the category might not be so apparent. For example, if the user started a search within the Yahoo! search path “Top:” and requested a search on “Ford” and “Michigan”, the category is unclear because the visitor might be interested in the Gerald R. Ford Library in Ann Arbor, Mich., or the visitor might be interested in the Ford Motor Company, which has offices in Michigan. One method of resolving the ambiguity is to examine the resulting clickstream. For example, a Yahoo! search directory search using the search phrase “Ford Michigan” might return several matches, including those shown in Table 1.

TABLE 1
Regional > U.S. States > Michigan > Cities > Ann Arbor > Education >
College and University > Public > University of Michigan > Libraries and
Museums

Gerald R. Ford Library

Regional > U.S. States > Michigan > Metropolitan Areas > Detroit
Metro > Business and Shopping > Shopping and Services > Automotive >
Dealers > Makes

Ford

When a user is presented with the entries shown in Table 1 and selects the first clickable link (Gerald R. Ford Library), the categorizer would assign the count for the event to the “Libraries and Museums” subcategory (and to each higher level subcategory if such tracking is performed). However, if the user selects the second clickable link, the categorizer assigns the second category/subcategory path shown in Table 1.

Where the categories tracked by the statistics monitor overlap the category structure of the search directory, the task of assigning counts is complete. However, where the structure of the statistics monitor does not overlap the structure of the search directory, some additional steps might be performed. For example, if the statistics monitor had categories for each U.S. state and categories for each U.S. President, then the count for the search term “Ford Michigan” followed by a click on the first clickable link in Table 1 might result in the statistics monitor assigning half a count to the category for Michigan and half a count to the category for former U.S. President Gerald R. Ford.

In addition to categorizing according subjects, events may further be categorized according to demographic information. For example, the traffic monitor 300 can provide the overall counts for the category “music”, but the traffic monitor 300 can also divide up the overall counts by different demographic categories, using user-provided demographic data or demographic data provided in another way. For example, the traffic monitor 300 can provide counts for the demographic of 18-45 males with U.S. addresses. An example of demographic information other than user-provided information is the user's client's IP (Internet Protocol) address. Examples of user-provided information include age, gender, residence location, and user preferences, such as browser type, client type, network type, etc. In addition to slicing up the data to show traffic for a particular demographic, the demographic data can be used to show how a particular count for a topic is divided up among the demographic categories. For example, the traffic monitor 300 can provide counts for the demographic of 18-45 males with U.S. addresses under the category “music”. Various embodiments and variations of categorizer 314 and methods of categorization are described in more detail in Yoo.

3. Count Generation

Count generator 316 counts the number of events in a particular category, subcategory, etc. Numerous methods of counting such events may be employed. For example, counts may be calculated as the number of unique users searching for a particular subject, viewing a page of content relevant to that subject, etc. Alternatively, counts may be calculated without regard to whether each event counted is originated by a unique user. For events that are purchase events, the amount of the increment may be a function of the purchase amount, so that, for example, purchases of larger amounts have a larger effect on the count than purchases of smaller amounts. Various embodiments and variations of count generator 316 and methods of generating of counts are described in more detail in Yoo.

4. Variations

In one variation, the count associated with a particular term or category is the number of users searching on that term, or viewing a page related to that term, divided by a sum of users searching, where the sum can be the sum of users searching over all subcategories in a category, sum of users searching over all terms in a category, or sum of all users searching anywhere on the site. The latter normalization is useful to factor out time-based increases in traffic, such as weekday-weekend patterns, seasonal patterns and the like. A normalization factor might be applied to all terms being compared so that the counts are easily represented. For example, if there are four terms in a category, 100 total unique user hits on those four terms (25, 30, 40 and 5, respectively) out of one million total unique users, a normalization factor of 100,000 might be applied so that the counts are 2.5, 3, 4 and 0.5, instead of 0.000025, 0.00003, 0.00004 and 0.000005. Normalization can also be used when determining the interest surrounding one company or product against an index of other companies or products within a particular market segment or product category.

In another variation, robot filtering may be used to identify events originating from computers/computer programs, rather than humans. Such events may skew counts and thus, a false indication of a level of interest in a subject might result. Various embodiments and variations of the traffic monitor 300 are described in more detail in Yoo.

Providing On-Line Interest Data for the Behavior Predictor

Referring again to FIG. 1, the aggregate on-line interest data 112 may be obtained using any one or more of the above-described techniques, or like techniques. For example, in the context of predicting economic activity related to a movie, the aggregate on-line interest data may comprise one or more of counts of page hits for a web page promoting the movie, counts of page hits for a web page promoting a lead actor in the movie, the number of search requests on a Web site for the movie's title, the number of search requests on a Web site for the lead actor's name, the stock price of a movie and/or its lead actor as reported by the Hollywood Stock Exchange, the Yahoo! Buzz Index of a movie and/or its lead actor as reported by the Yahoo! portal site, and the like. Additionally, the aggregate on-line interest data may also be obtained using a traffic monitor, such as the traffic monitor described in Yoo. Further, not all of the techniques described in Yoo need be used. For example, canonicalization need not be used. Also, categorization need not be used. For example, a traffic monitor similar to that described in Yoo, but not employing categorization, could be used to count events related to the subject for which on-line interest is to be measured.

Data Used by Behavior predictor to Predict Box Office Sales of a Movie

Referring again to FIG. 1, behavior predictor 110 uses aggregate on-line interest data 112 relating to a subject, and may also use subject characteristics data 114, to generate a prediction of a aggregate behavior related to the subject. Types of on-line interest data and subject characteristics data that may be used by behavior predictor to generate a prediction of aggregate behavior will be described in the context of an example. Particularly, types of data used in predicting box office sales of a movie will be described. One skilled in the art will recognize how similar data for other types of products can be used to obtain predictions related to other products.

Many types of data may be used to predict aggregate behavior related to a subject according to the present invention. The following data have been determined through experimentation to provide accurate predictions of a measure of economic activity related to movies. Particularly, the following data have been determined to be highly correlated with box office sales of a movie.

1. On-Line Interest Data

Table 2 lists on-line interest data that have been determined to be highly correlated with box office sales of a movie during its first week of release. This aggregate on-line interest data may be obtained using the methods and the systems described in Yoo. Such data may also may obtained using other similar methods and systems. Additionally, similar data may be obtained using any of the other techniques for measuring aggregate on-line interest described above, or the like. In particular, Table 2 lists subjects, categories, subcategories, etc. in which counts, normalized counts, usage statistics, etc. may be obtained and provided to the behavior predictor.

TABLE 2

Overall>Entertainment>Movies> [the movie's genre] >

[the movie's title]

Overall>Entertainment>Movies>

[the movie's title]

Overall>

[the movie's title]

Overall>Entertainment>Movies>

[the movie's lead actor]

Overall>

[the movie's lead actor]

The category “Overall” may be the top of the hierarchical tree. Within “Overall” may be included subjects such as, for example, “Apparel,” “Autos,” “Entertainment,” “Travel,” etc. Within the subject “Entertainment” may be included subcategories such as, for example, “Amusement Parks,” “Movies,” “Music,” “Television,” etc. The subcategory “Movies,” may include subcategories of movie genres such as, for example, “Action and Adventure,” “Animation,” “Comedy,” “Drama,” “Science Fiction,” etc.

In a specific embodiment, normalized counts for the subjects, categories, etc., listed in Table 2 are obtained for the 60 days prior to the movie's release. Also, normalized counts for the subjects, categories, etc., listed in Table 2, but for other movies of the same genre, may be obtained for the 60 days prior to the movie's release. Additionally, a demographic breakdown of the normalized counts may be obtained. For example, the counts in each of the subjects, categories, etc., of Table 2 may be further categorized by gender and age. In some embodiments, it may be useful to further categorize by, for example, geographic area, employment status, occupation, marital status, etc. The above data are then provided to the behavior predictor.

2. Subject Characteristics Data

In the specific embodiment, the data listed in Table 3 are also provided to the behavior predictor. This data has been determined to be highly correlated with box office sales of a movie during its first week of release. The data in Table 3 may be obtained using any of numerous methods or systems known to those skilled in the art.

TABLE 3
The number of theaters showing the movie
The genre of the movie
The rating of the movie by the Classification and Rating Administration
(CARA)
The name(s) of the lead actor or actors

It is to be understood that many variations of the above described aggregate on-line interest data and other subject characteristics data may also be employed with embodiments of the present invention that are used to predict movie box office sales. For example, on-line interest data in Table 2 can be obtained for more or less than 60 days prior to the movie's release. Additionally, normalized counts from other subjects, may also be provided to the behavior predictor. Also, the data need not be normalized. Moreover, data from all of the subjects, categories, etc., listed in Table 2 need not be provided to the behavior predictor. Those skilled in the art will recognize many other variations, modifications, and alternatives.

Generating a Prediction

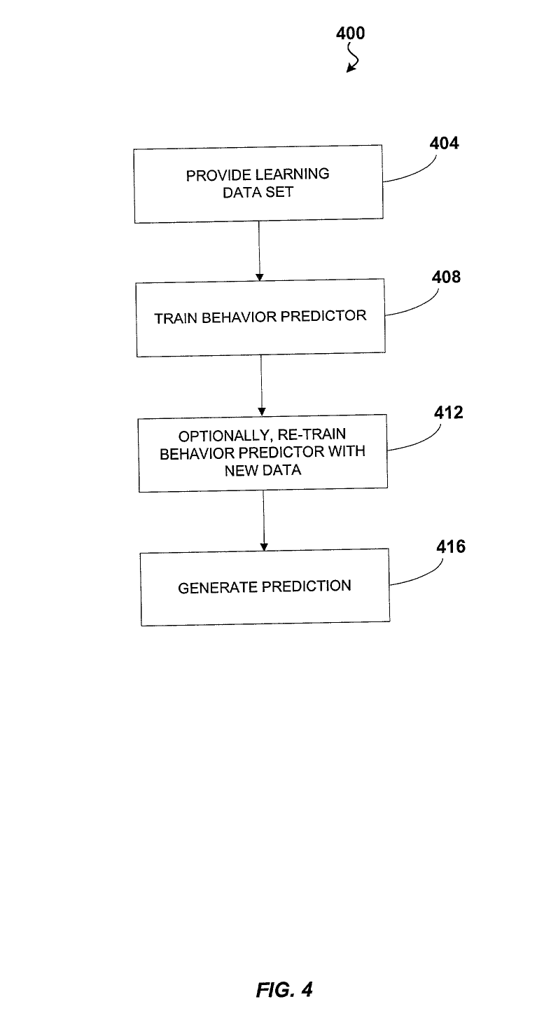

FIG. 4 is a simplified flow diagram of a method according to another embodiment of the invention. Particularly, FIG. 4 is a simplified flow diagram of a method for generating a prediction of aggregate behavior related to a subject. This method may be implemented by a system such as that described with respect to FIG. 1, or the like. This diagram is used herein for illustrative purposes only and is not intended to limit the scope of the invention.

In a step 404, a learning data set is provided. The learning data set may include aggregate on-line interest data relating to subjects similar to the subject for which aggregate behavior is to be predicted (i.e., subjects of a same type), subject characteristics data for the similar products, and actual aggregate behavior data related to the similar subjects. The learning data set will be further explained in the context of the example of predicting box office sales of a movie. Particularly, in a specific embodiment, the learning data set may include the on-line interest data described with reference to Table 2 and the subject characteristics data described with reference to Table 3 for a plurality of movies for which box office sales data is already available. Additionally, the learning data set includes the actual box office sales for those movies (i.e., actual activity data).

Next, in a step 408, the behavior predictor is trained using the learning data set. Depending upon the behavior predictor used in any particular implementation (e.g., linear regression model, regression tree, neural network, or other learning algorithms), different techniques for training the predictor may be used. As described previously, in embodiments employing a statistical model, the model generally generates predictions as a weighted combination of the model inputs (i.e., the on-line interest data and/or subject characteristics data). The model is generally trained to determine input weights that maximize the accuracy of predictions generated by the model using the on-line interest data and/or subject characteristics data included in the learning data set. The accuracy of the predictions is measured using the actual aggregate behavior data in the learning data set. One skilled in the art will recognize numerous techniques for determining weights such that the accuracy of the model is maximized. As but one example, the weights may be determined such that the mean-square error of the model's predictions is minimized.

As new data becomes available, the behavior predictor may optionally be retrained in a step 412. For example, in some embodiments, the new data may be added to the learning data set, and the step 408 may be repeated using the updated learning data set. In other embodiments, the behavior predictor may be incrementally adjusted using only the new data, or the new data in combination with a subset of the data in the learning data set. One skilled in the art will recognize many other variations, modifications, and alternatives. Step 412 may optionally be repeated as new data becomes available.

Once the behavior predictor has been trained, it may be used to predict a measure of economic activity related to a product in a step 416. In embodiments employing a statistical model, the model generally generates a prediction by applying the weights determined in step 408 (and optionally, step 412) to the on-line interest data and/or subject characteristics data relating to the subject for which aggregate behavior is to be predicted.

Types of Behavior That Can Be Predicted

In the above description, the present invention has been described in the context of predicting a measure of economic activity related to a movie (e.g., box office sales). It is to be understood, however, that the present invention can be used to predict a measure of economic activity related to many other types of products. For example, embodiments of the present invention could be used in the context of, for example, predicting rentals or sales of video tapes, audio tapes, compact disks (CDs), digital video disks (DVDs), etc.), predicting sales of books, pharmaceutical products, automobiles, toys, consumer electronics, appliances, etc. Additionally, the economic activity predicted could be a number of, or monetary value of, sales or rentals during a period of time or at a point in time. Also, the prediction could be of a range in sale or rental price or of a rate of sales/rentals during a period of time. Further, embodiments of the present invention could be used to predict an opening price, closing price, a range in price, etc. of a financial security, such as, for example, a stock, bond, etc.

Moreover, embodiments of the present invention may be used to predict many other types of aggregate behavior of a population. For example, embodiments of the present invention may be used to predict an extent of a disease in a population.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

What is claimed is:

1. A method of predicting aggregate behavior of a population, the method comprising:
providing a modeling system configured to model aggregate behavior of a population as a function of aggregate on-line interest data, the on-line interest data based on passive observation of on-line behavior of a subpopulation, wherein the on-line behavior is related to, but different than, the behavior to be modeled, and wherein the subpopulation comprises a subset of the population;
inputting to the modeling system on-line interest data related to a subject;
generating, with the modeling system, a prediction of aggregate behavior related to the subject.

2. The method of claim 1 wherein the modeling system is further configured to model aggregate behavior of the population as a function of characteristics of the subject to which the aggregate behavior is related, the method further comprising inputting to the modeling system data related to characteristics of the subject.

3. The method of claim 1 further comprising training the modeling system with a learning data set, the learning data set including:
on-line interest data related to another subject, the another subject related to the subject; and
actual aggregate behavior data relating to the another subject.

4. The method of claim 1 wherein the on-line interest data includes on-line usage data.

5. The method of claim 1 wherein the aggregate behavior to be modeled is aggregate economic activity.

6. The method of claim 5 wherein the aggregate economic activity to be modeled is related to a product.

7. The method of claim 6 wherein the product is selected from the group consisting of a movie, a video tape, a CD, a DVD, a model of automobile, a book, a toy, an appliance, an electronic device, a pharmaceutical product, and a software product.

8. The method of claim 5 wherein the aggregate economic activity to be modeled is related to a service.

9. The method of claim 5 wherein the aggregate economic activity to be modeled is related to a financial security.

10. The method of claim 1 wherein the aggregate behavior to be modeled is an extent of a disease.

11. A system for predicting aggregate behavior of a population, the system comprising:
a modeling system configured to model aggregate behavior of a population as a function of aggregate on-line interest data, the on-line interest data based on passive observation of on-line behavior of a subpopulation, wherein the on-line behavior is related to, but different than, the behavior to be modeled, and wherein the subpopulation comprises a subset of the population; and
a module for receiving on-line interest data related to a subject and providing the on-line interest data to the modeling system;
wherein the modeling system generates a prediction of aggregate behavior related to the subject using the on-line interest data.

12. The system of claim 11 wherein the modeling system is further configured to model aggregate behavior of a population as a function of characteristics of the subject to which the aggregate behavior is related, the system further including a module for receiving data related to characteristics of the subject and providing the data related to characteristics of the subject to the modeling system.

13. The system of claim 11 further including a training module that trains the modeling system with a learning data set, wherein the learning data set includes:
on-line interest data related to another subject, the another subject related to the subject; and
actual aggregate behavior data relating to the another subject.

14. A method of training a modeling system to predict aggregate behavior of a population, the method comprising:
providing a modeling system;
providing a learning data set including:
actual aggregate behavior data related to a first subject; and
aggregate on-line interest data related to the first subject, the on-line interest data based on passive observation of on-line behavior of a subpopulation, wherein the on-line behavior is related to, but different than, the actual behavior, and wherein the subpopulation comprises a subset of the population;
training the modeling system with the learning data set to minimize the error between a predicted aggregate behavior related to the first subject generated by the modeling system and the actual aggregate behavior related to the first subject.

15. The method of claim 14 wherein the learning data set further includes:
actual aggregate behavior data related to a second subject related to the first subject; and
aggregate on-line interest data related to the second subject, the on-line interest data related to the second subject based on passive observation of on-line behavior of the subpopulation, wherein the on-line behavior is related to, but different than, the actual behavior;
wherein training the modeling system with the learning data set includes minimizing the mean-square error between the predicted aggregate behavior related to the first subject generated by the modeling system and the actual aggregate behavior related to the first subject and between a predicted aggregate behavior related to the second subject generated by the modeling system and the actual aggregate behavior related to the second subject.

16. A method of predicting a measure of aggregate economic activity related to a product, the method comprising:
providing a modeling system configured to model aggregate economic activity of a type of product as a function of aggregate on-line interest data related to products comprising the type, wherein the on-line interest data is based on passive observation of on-line behavior of a subpopulation, wherein the on-line behavior is related to, but different than, the economic activity to be modeled, and wherein the subpopulation comprises a subset of a population that engages in the economic activity to be modeled;
inputting to the modeling system on-line interest data related to a first product comprising the type; and
generating a prediction of the measure of aggregate economic activity related to the first product with the modeling system.

17. The method of claim 16 wherein the modeling system is further configured to model aggregate economic activity of the type of product as a function of characteristics of products comprising the type, the method further comprising inputting to the modeling system data related to characteristics of the first product.

18. The method of claim 17 further comprising training the modeling system with a learning data set, the learning data set including:
on-line interest data related to a second product comprising the type;
data related to characteristics of the second product; and
aggregate economic activity data relating to the second product.

19. The method of claim 18 wherein training the model includes:
adding to the learning data set additional data related to characteristics of the second product; and
retraining the modeling system with the learning data set.

20. The method of claim 16 further comprising training the modeling system with a learning data set, the learning data set including:
on-line interest data related to a second product comprising the type; and
aggregate economic activity data relating to the second product.

21. The method of claim 20 wherein training the model includes:
adding to the learning data set additional on-line interest data related to the second product; and
retraining the modeling system with the learning data set.

22. The method of claim 16 wherein the on-line interest data related to the first product includes counts of page hits of a web page related to the first product.

23. The method of claim 16 wherein the on-line interest data related to the first product includes counts of search queries at a web site that include a phrase related to the first product.

24. The method of claim 16 wherein the on-line interest data related to the first product includes an on-line interest measurement provided by a web site.

25. The method of claim 24 wherein the on-line interest measurement provided by a web site is a fictional stock price of the first product.

26. The method of claim 24 wherein the on-line interest measurement provided by a web site is a percentage of users of the web site initiating searches related to the first product.

27. The method of claim 16 wherein the on-line interest data related to the first product includes aggregate Internet usage data related to the first product.

28. The method of claim 27 wherein the aggregate Internet usage data related to the first product includes statistics based on analyses of online events related to the first product.

29. The method of claim 28 wherein online events include a result of a client making a request of a server and the server providing a response to the client.

30. The method of claim 28 wherein the analyses of online events includes:
automatically associating each online event with one or more subjects;
accumulating counts for events by subject; and
outputting the accumulated counts for each subject.

31. The method of claim 30 wherein the analyses of online events further includes:
identifying one or more categories relevant to each subject;
accumulating counts for events by category; and
outputting the accumulated counts for each category.

32. The method of claim 30 wherein the analyses of online events further includes determining if a subject for an event is a canonical equivalent of another subject; and wherein counts for canonical equivalents are accumulated together.

33. The method of claim 30 wherein the analyses of online events further includes normalizing counts for events over a field of events, and wherein outputting the accumulated counts includes outputting the normalized counts.

34. The method of claim 30 wherein the analyses of online events further includes:
determining a set of one or more demographic parameters relating to users that prompt the events; and
using the set of one or more demographic parameters to partition the counts by demographic divisions.

35. The method of claim 16 wherein the first product is selected from the group consisting of a movie, a video tape, a CD, a DVD, a model of automobile, a book, a toy, an appliance, an electronic device, a pharmaceutical product, and a software product.

36. The method of claim 16 wherein the predicted measure of aggregate economic activity is a predicted number of sales during a period of time.

37. The method of claim 16 wherein the predicted measure of aggregate economic activity is a predicted monetary value of sales during a period of time.

38. A system for predicting a measure of aggregate economic activity related to a product, the system comprising:
a modeling system configured to model aggregate economic activity of a type of product as a function of aggregate on-line interest data related to products comprising the type, wherein the on-line interest data is based on passive observation of on-line behavior of a subpopulation, wherein the on-line behavior is related to, but different than, the economic activity to be modeled, and wherein the subpopulation comprises a subset of a population that engages in the economic activity to be modeled; and
a module for receiving on-line interest data related to a first product comprising the type and providing the on-line interest data to the modeling system;
wherein the modeling system generates a predicted measure of economic activity related to the first product using the on-line interest data.

39. The system of claim 38 wherein the modeling system is further configured to model aggregate economic activity of the type of product as a function of characteristics of products comprising the type, the system further including a module for receiving data related to characteristics of the first product and providing the data related to characteristics of the first product to the modeling system.

40. The system of claim 39 further including a training module that trains the modeling system with a learning data set, wherein the learning data set includes:
on-line interest data related to a second product comprising the type;
data related to characteristics of the second product; and
aggregate economic activity data related to the second product.

41. The system of claim 38 further including a training module that trains the modeling system with a learning data set, wherein the learning data set includes:
on-line interest data related to a second product comprising the type; and
aggregate economic activity data related to the second product.

42. The system of claim 38 further comprising an aggregate Internet usage statistics generator that provides aggregate Internet usage statistics related to the first product to the module for receiving on-line interest data.

43. The system of claim 42 wherein the aggregate Internet usage statistics generator includes:
an activity input for receiving data related to events on a set of servers;
means for categorizing events into categories;
means for associating events with subjects, wherein counts are maintained for each subject and wherein subjects are associated with categories;
a normalizer for normalizing counts for events over a field of events; and
a result output for outputting results of the normalizer as the online usage statistics.

44. A method of training a modeling system to predict aggregate economic activity related to a product comprising a type of products, the method comprising:
providing a modeling system;
providing a learning data set including:
an actual measure of aggregate economic activity related to a first product comprising the type; and
aggregate on-line interest data related to the first product, the on-line interest data based on passive observation of on-line behavior of a subpopulation, wherein the on-line behavior is related to, but different than, the actual economic activity, and wherein the subpopulation comprises a subset of a population that engages in the economic activity;
training the modeling system with the learning data set to minimize the error between a predicted measure of aggregate economic activity related to the first product as generated by the modeling system and the actual measure of aggregate economic activity related to the first product.

45. The method of claim 44 wherein the learning data set further includes:
an actual measure of aggregate economic activity related to a second product comprising the type;
aggregate on-line interest data related to the second product, the on-line interest data based on passive observation of on-line behavior of the subpopulation, wherein the on-line behavior is related to, but different than, the actual economic activity;
wherein training the modeling system with the learning data set includes minimizing the mean-square error between the predicted measure of aggregate economic activity related to the first product generated by the modeling system and the actual measure of aggregate economic activity related to the first product and between the predicted measure of aggregate economic activity related to the second product generated by the modeling system and the actual measure of aggregate economic activity related to the second product.
